(19) United States
(12) Patent Application Publication
(10) Pub. No.: US 2008/0099982 A1
(43) Pub. Date: May 1, 2008

(54) Feeding cassette, recording apparatus, and liquid ejecting apparatus

(75) Inventors: Tsuyoshi Yamanaka, Yukuhashi-shi (JP); Hiroyuki Tajima, Kitakyushu-shi (JP)

Correspondence Address: WORKMAN NYDEGGER, 60 EAST SOUTH TEMPLE, 1000 EAGLE GATE TOWER, SALT LAKE CITY, UT, 84111, US

(73) Assignee: SEIKO EPSON CORPORATION, Tokyo (JP)

(21) Appl. No.: 11/866,292

(22) Filed: Oct. 2, 2007

(30) Foreign Application Priority Data
Oct. 3, 2006 (JP) 2006-271890

(51) Int. Cl. B65H 1/26; B41J 2/01

(52) U.S. Cl. 271/157; 347/104

(57) ABSTRACT

[Solving Means] A feeding cassette 1 according to the present invention includes a cassette body 38 capable of holding many recording media P in a stacked state, edge guides 15A and 15B that guide left and right side edges of the recording media P held in the cassette body 38, and a hopper 16 that pushes up the recording media held in the cassette body, wherein the edge guides are provided so as to protrude downward with respect to an inner wall surface of a top face 40 of the cassette body.

### BACKGROUND

1. Technical Field

The present invention relates to a feeding cassette comprising a cassette body that can hold many recording media in a stacked state, an edge guide that guides left and right side edges of the recording media held in the cassette body, and a hopper that pushes up the recording media held in the cassette body; and a recording apparatus to which the feeding cassette can be mounted.

Further, the present invention relates to a liquid ejecting apparatus, such as an ink jet recording apparatus, that discharges, that is, ejects a liquid, such as ink, from its head, and causes the liquid to adhere to a recording medium, that is, a liquid ejection medium; and to a feeding cassette that can be mounted to the liquid ejecting apparatus.

Here, the liquid ejecting apparatus refers, not only to recording apparatuses, such as a printer, a plotter, a copying machine, and a facsimile, that use an ink jet recording head and that discharge ink from the recording head to perform recording on a recording medium, but also to an apparatus that ejects, in place of the ink, a liquid corresponding to the intended use onto a liquid ejection medium, corresponding to a recording medium, from a liquid ejecting head, corresponding to the recording head, to adhere the liquid to the liquid ejection medium.

In addition to the recording head, examples of the liquid ejecting head include a coloring-material ejecting head used in manufacturing a color filter of, for example, a liquid crystal display; an electrode-material (conductive paste) ejecting head used in forming electrodes in, for example, an organic EL display or a surface-emitting display (FED); a bio-organic-material ejecting head used in manufacturing a biochip; and a sample ejecting head serving as a precision pipette.

2. Related Art

As indicated in the following Patent Document 1, a related feeding cassette comprises a cassette body, whose bottom face and front end face, back end face and left and right side faces are closed, and whose top face is open; and a top cover provided so as to cover the open top face of the cassette body. An opening having a relatively large diameter is provided in the bottom face of the cassette body, and entrance of a portion of a hopper into the opening from therebelow causes a recording medium held in the cassette body to be pushed up towards a feeding roller, so that feeding can be performed. A movable edge guide that is slidable in the widthwise and lengthwise direction of the cassette body is provided on the bottom face of the cassette body so that recording media of various sizes can be used.

Adjustment of the position of the edge guide is performed by a user side; and, each time a user replenishes or replaces a recording medium, the user unlocks the edge guide and moves the edge guide in an enlargement direction or a contraction direction, to lock the edge guide along the left and right side edges and the back end edge of a recording medium that is newly replaced. However, since variations occur in the precision with which the positions of the edge guide is adjusted depending upon a user, the position of the edge guide is not stable, as a result of which the recording medium may not be properly fed.

In addition, in the related feeding cassette, structurally speaking, a gap is formed between the inner wall surface of the top cover and the top end face of the edge guide. Therefore, when the recording medium pushed upward by the hopper reaches the gap, it separates from a guide surface of the edge guide, thereby causing the orientation of the recording medium to become unstable, as a result of which skewing (tilting of the recording medium) tends to occurs.

[Patent Document 1] Japanese Unexamined Patent Application Publication No. 62-65839

### SUMMARY

An object of the present invention is to provide an easy-to-handle feeding cassette which, regardless of the number of stacked recording media and raising/lowering positions of a hopper, can hold a recording medium in a stable orientation, and prevent improper feeding of the recording medium caused by positional displacement of an edge guide; and, for example, a recording apparatus to which the feeding cassette can be mounted.

To this end, a feeding cassette according to a first embodiment of the present invention comprises a cassette body capable of holding many recording media in a stacked state, an edge guide that guides left and right side edges of the recording media held in the cassette body, and a hopper that pushes up the recording media held in the cassette body, wherein the edge guide is provided so as to protrude downward with respect to an inner wall surface of a top face of the cassette body.

According to the first embodiment of the present invention, since the edge guide is provided at the top face side of the cassette body, a gap existing between the top end surface of the edge guide and the inner wall surface of the top cover of the related feeding cassette does not exist. Therefore, even if the recording medium is pushed upward by the hopper, the left and right side edges of the recording medium are held by the edge guide, so that the orientation of the recording medium is stabilized, as a result of which proper feeding of the recording medium is executed.

A feeding cassette according to a second embodiment of the present invention comprises a cassette body having a top face, a front end face, a back end face, a left side face, and a right side face integrally formed, having an open bottom face, and capable of holding many recording media; a hopper provided at the cassette body as a structural member forming the bottom face, supporting the recording media held in the cassette body, capable of swinging with a back end as a swing fulcrum, and pushing up the recording media from below by the swinging; an opening provided in the top face at the front-end-face side of the cassette body; and an edge guide protruding downward with respect to an inner wall surface of the top face of the cassette body, and guiding left and right side edges of the recording media.

In addition to providing the operational advantages that are similar to those of the first embodiment, the second embodiment of the present invention is such that, since the swingable structure of the hopper causes the recording medium to reciprocate (move vertically) while it is placed flat on the hopper, the recording medium is guided by the guide edge, so that its orientation is further stabilized, thereby making it possible to realize a more proper feeding operation.

In the first embodiment or the second embodiment, in a feeding cassette according to a third embodiment of the present invention, the edge guide is provided in a fixed state in accordance with a size of the recording media held in the cassette body.

According to the third embodiment of the present invention, it is possible to save the trouble of adjusting the position of the edge guide in accordance with the size of the recording medium that is used, so that positional displacement of the edge guide occurring in the related art due to the positional adjustment no longer occurs, thereby stabilizing and making proper the feeding state of the recording medium.

In the third embodiment, in a feeding cassette according to a fourth embodiment of the present invention, the hopper is formed with a form corresponding to the size of the recording media held in the cassette body so as not to interfere with the edge guide.

According to the fourth embodiment of the present invention, since the edge guide does not interfere with the raising and lowering of the hopper, the hopper is smoothly raised and lowered. In addition, since the entire bottom surface of the recording medium set at the cassette body is supported by the hopper, the recording medium whose stable orientation is maintained is pushed towards and against the feeding roller, so that proper feeding is realized.

In the third embodiment or the fourth embodiment, in a feeding cassette according to a fifth embodiment of the present invention, a placement face of the hopper is formed so as to be positioned in an area interposed between guide surfaces of the edge guide.

According to the fifth embodiment of the present invention, since the left and right side edges of the recording media stacked in the cassette body are always held by the guide surface of the edge guide, the orientation of the recording media is always stable regardless of the raising/lowering position of the hopper, so that proper feeding of the recording media without skewing is realized.

In any one of the third to fifth embodiments, in a feeding cassette according to a sixth embodiment of the present invention, the edge guide is formed integrally with the cassette body, and a protruding end of the edge guide is formed flush with the open bottom face of the cassette body. Here, “flush with” in “the protruding end of the edge guide is formed flush with the open bottom face of the cassette body” does not strictly mean that it is flush with the face, on which the recording media are placed, of a structural member that forms the bottom surface of, for example, the hopper. It is set so that all the stacked recording media positioned from the highest level to the lowest level can be pushed smoothly upward in an area between opposing left and right guides, so that “flush with” need not strictly mean “match.”

According to the sixth embodiment of the present invention, since the number of parts and the assembly man-hours can be reduced, the parts costs and assembly costs of the feeding cassette can be reduced. In addition, since the edge guide operates as a reinforcing rib that reinforces the cassette body, the mechanical strength of the cassette body can be increased. Further, by making the protruding end of the edge guide flush with the bottom face of the cassette body, entry of dust from the outside is reduced, and the appearance of the feeding cassette is nice.

A recording apparatus according to a seventh embodiment of the present invention is a recording apparatus to which a feeding cassette is mountable, wherein the feeding cassette comprises a cassette body capable of holding many recording media in a stacked state, an edge guide that guides left and right side edges of the recording media held in the cassette body, and a hopper that pushes up the recording media held in the cassette body towards a feeding roller. The feeding cassette is the feeding cassette according to any one of the first to fifth embodiments.

According to the seventh embodiment of the present invention, it is possible to provide a recording apparatus to which the feeding cassette is mountable, the feeding cassette being an easy-to-handle feeding cassette which, regardless of the number of stacked recording media and raising/lowering positions of the hopper, can always maintain the recording media in a stable orientation, and prevent improper feeding of the recording media caused by positional displacement of the edge guide.

A liquid ejecting apparatus according to an eighth embodiment of the present invention is a liquid ejecting apparatus to which a feeding cassette is mountable, wherein the feeding cassette comprises a cassette body capable of holding many liquid ejection media in a stacked state, an edge guide that guides left and right side edges of the liquid ejection media held in the cassette body, and a hopper that pushes up the liquid ejection media held in the cassette body towards a feeding roller, and wherein the edge guide is provided so as to protrude downward with respect to an inner wall surface of a closed top face of the cassette body.

### BRIEF DESCRIPTION OF THE DRAWINGS

### Brief Description of the Drawings

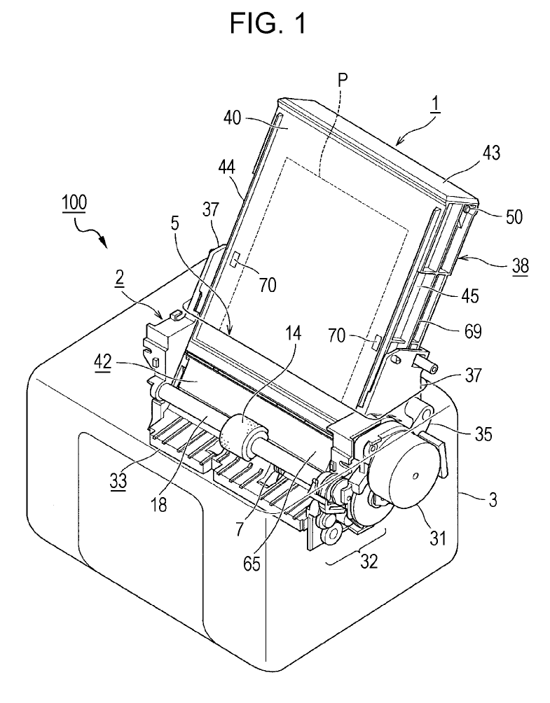

FIG. 1 is an external perspective view of an ink jet printer.

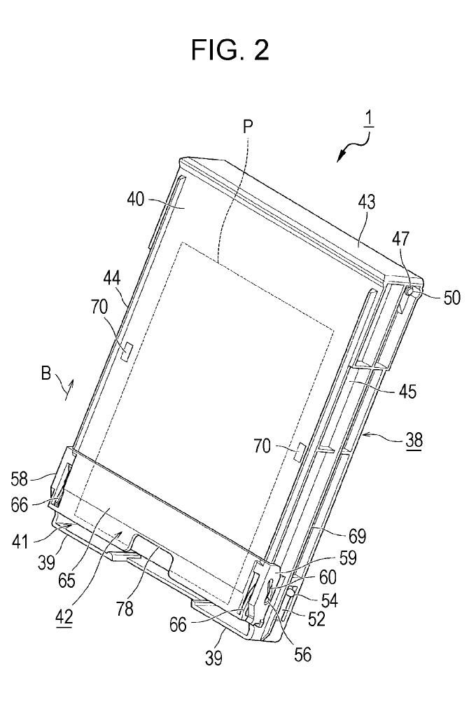

FIG. 2 is a perspective view of a feeding cassette when a shutter is opened.

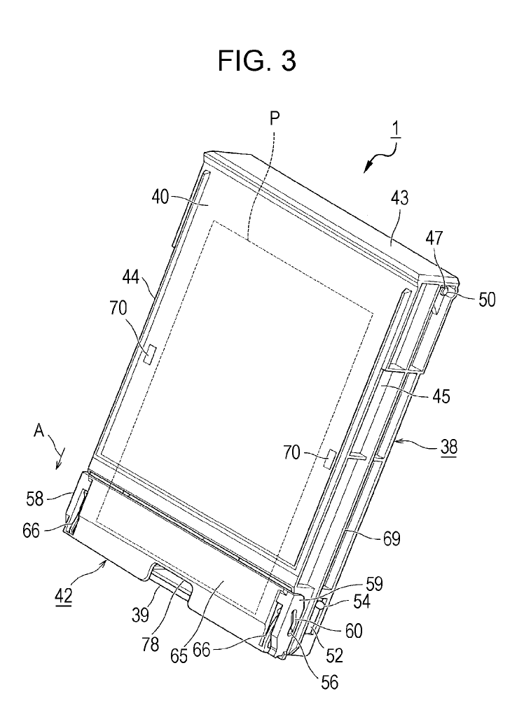

FIG. 3 is a perspective view of the feeding cassette when the shutter is closed.

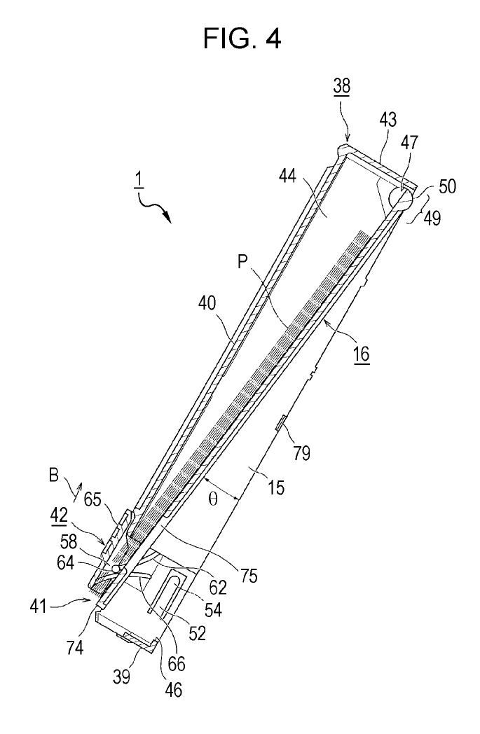

FIG. 4 is a side sectional view of the feeding cassette when a hopper is raised.

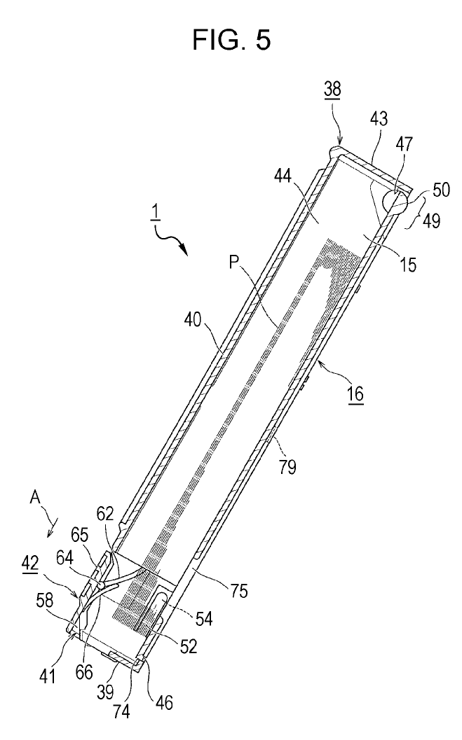

FIG. 5 is a side sectional view of the feeding cassette when the hopper is lowered.

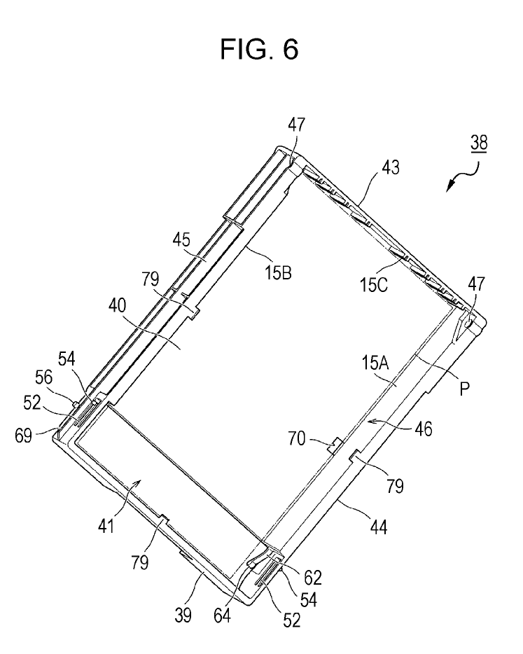

FIG. 6 is a perspective view of a cassette body for a 4×6 inch size.

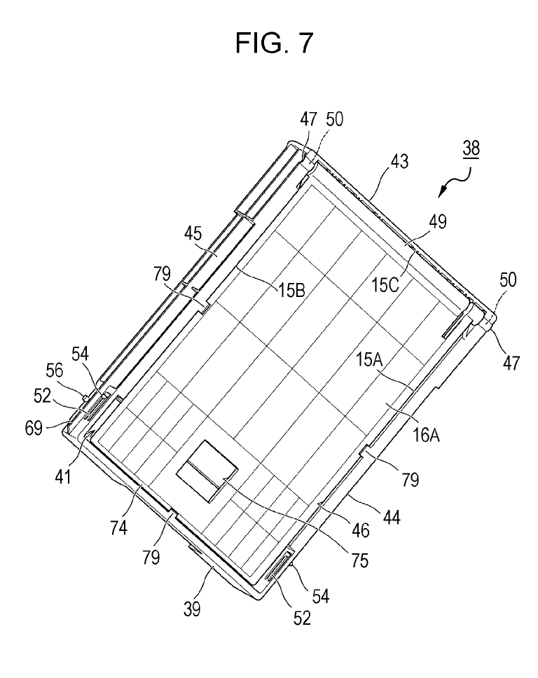

FIG. 7 is a perspective view showing a state in which a hopper is mounted in FIG. 6.

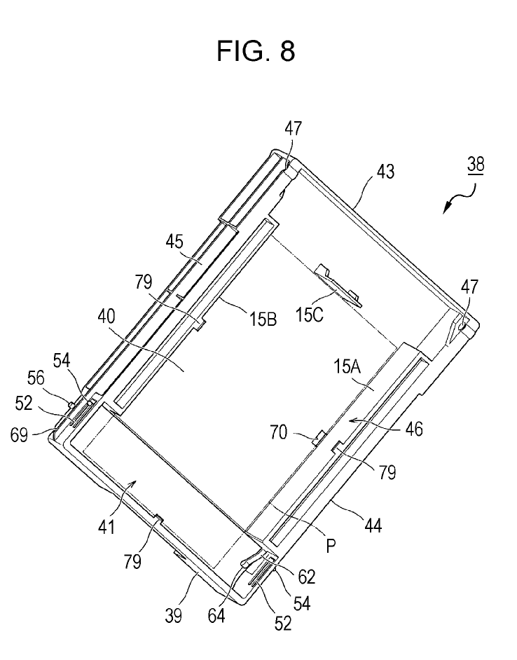

FIG. 8 is a perspective view of a cassette body for an L-format size.

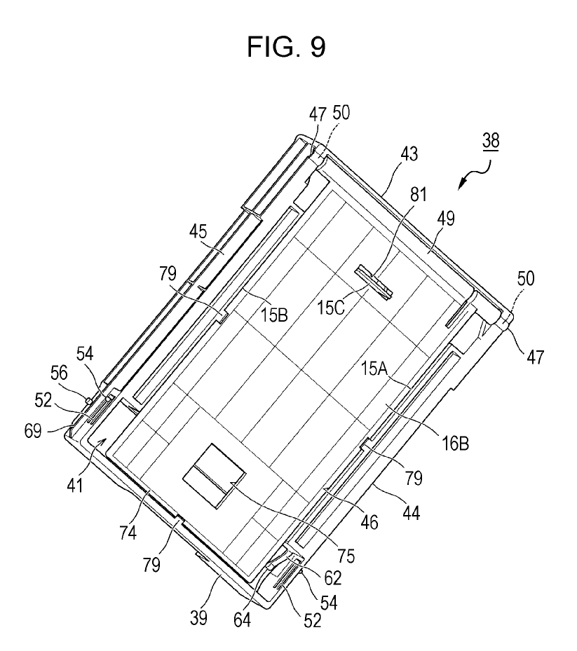

FIG. 9 is a perspective view showing a state in which a hopper is mounted in FIG. 8.

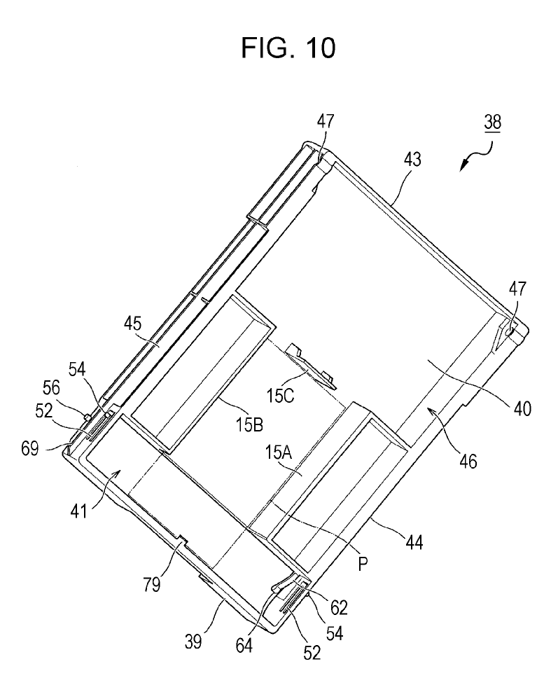

FIG. 10 is a perspective view of a cassette body for a card size.

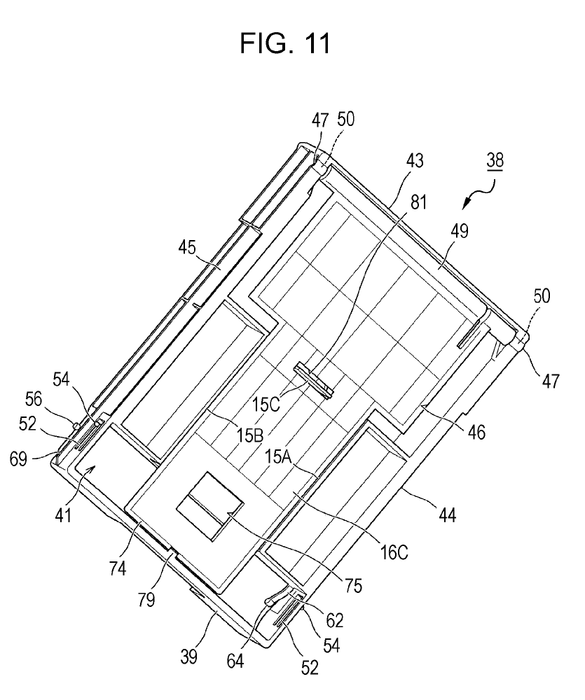

FIG. 11 is a perspective view showing a state in which a hopper is mounted in FIG. 10.

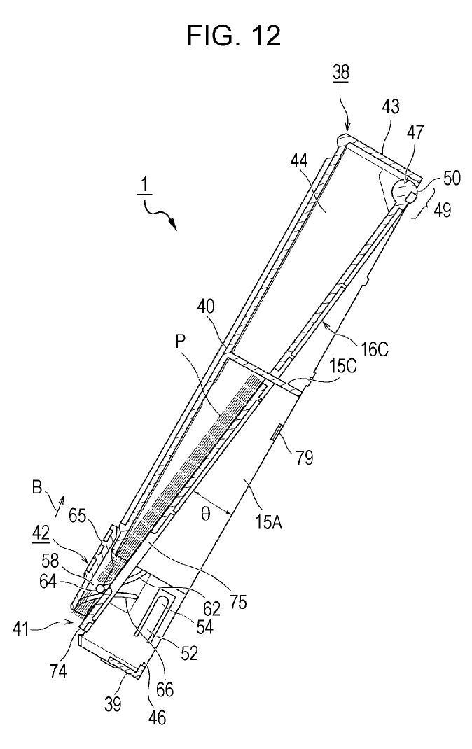

FIG. 12 is a side sectional view showing the feeding cassette to which a shutter is mounted in FIG. 11.

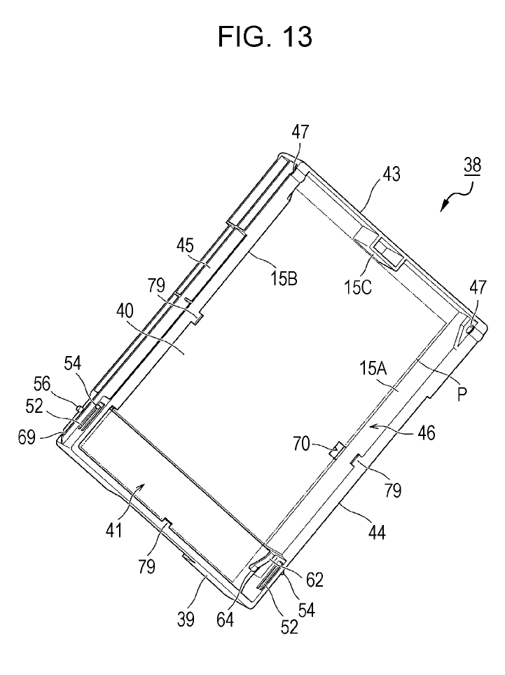

FIG. 13 is a perspective view of a cassette body for a postcard size.

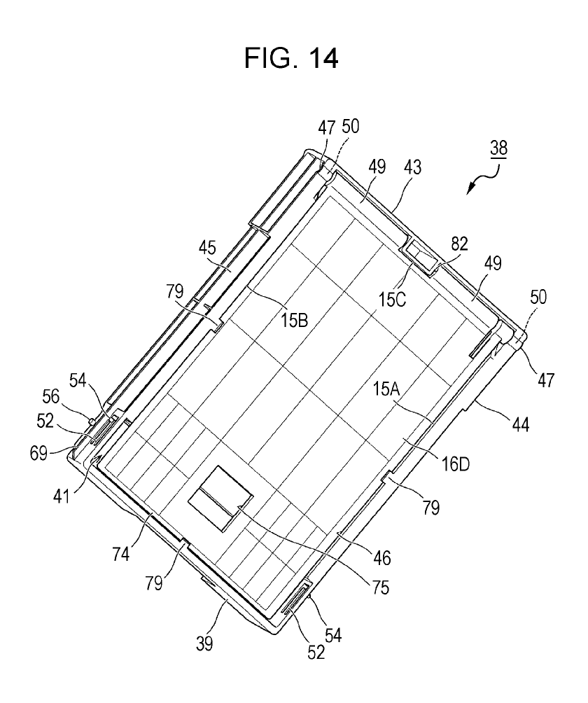

FIG. 14 is a perspective view showing a state in which a hopper is mounted in FIG. 13.

### REFERENCE NUMERALS

1 feeding cassette, 2 automatic feeding unit, 3 printer body (recording apparatus body), 5 upper-portion opening, 7 return lever, 14 feeding roller, 15 edge guide, 15A edge guide, 15B edge guide, 15C edge guide, 16 hopper, 16A hopper, 16B hopper, 16C hopper, 16D hopper, 18 rotatable shaft, 31 motor, 32 gear train, 33 unit holder, 35 hopper operating cam, 37 cassette guide, 38 cassette body, 39 front end face, 40 top face, 41 opening, 42 shutter, 43 back end face, 44 left side face, 45 right side face, 46 bottom face, 47 swing hole, 49 swing base end portion, 50 swing shaft, 52 elastic tongue, 54 engaging protrusion, 56 engaging pin, 58 left side plate, 59 right side plate, 60 engaging groove, 62 guide, 64 guide head, 65 cover plate, 66 elastic operating portion, 69 guide rib, 70 window, 74 swing free end, 75 opening, 78 cutaway portion, 79 stopper pawl, 81 window, 82 cutaway portion, 100 ink jet printer (recording apparatus) P sheet (recording medium), A closing direction, B opening direction, θ swing angle

### DESCRIPTION OF EXEMPLARY EMBODIMENTS

### Best Mode for Carrying Out the Invention

A feeding cassette according to the invention of the application and a recording apparatus, which is an example of a liquid ejecting apparatus to which the feeding cassette can be mounted, according to the invention of the application will hereunder be described. First, a liquid ejecting apparatus according to the invention of the application, and an ink jet printer 100, serving as a best mode for realizing the recording apparatus which is an example of the liquid ejecting apparatus, will be taken up to generally describe the entire structure thereof.

FIG. 1 is an external perspective view of the ink jet printer. The illustrated ink jet printer 100 is a relatively compact ink jet printer that is portable. The illustrated ink jet printer 100 is not provided with a feeding device having a hopper. In the illustrated ink jet printer 100, actually, a feeding cassette 1 can be removably mounted with its front side lower than its back side to a liquid ejecting apparatus body at which a feeding device is provided and to a top opening 5 situated towards the back portion side of a printer body 3, which is an example of a recording apparatus body.

In addition, recording media (may hereafter be simply referred to as sheets) P, which are examples of liquid ejection media held in the feeding cassette 1, are pushed upward by a pushing-up operation of a hopper 16 (FIG. 4). Starting from a topmost sheet P, the sheets P are successively drawn out and fed as a result of the hopper 16 cooperating with a feeding roller 14, that is, a pinch feeding operation. The feeding roller 14 is positioned facing an opening 41 (FIGS. 2 and 4) provided in the top face of the front end face side of a cassette body 38. The structure of the feeding cassette 1 will be described in detail below.

Related transporting rollers (not shown) comprising a pair of upper and lower transporting rollers, that is, a transporting driven roller and a transporting driving roller, are provided downstream from the feeding roller 14. The sheet P transported by the transporting rollers is guided to a recording position situated downstream in a sheet transportation direction (sub-scanning direction). A recording head (not shown), which is an example of a liquid ejecting head that discharges ink, which is an example of a liquid, onto and that performs direct recording on the sheet P, is positioned above the recording position. A platen (not shown) that supports the bottom surface of the sheet P is provided below the recording position, and defines a gap between the recording medium and the recording head, which is important to recording quality.

The recording head is installed at the lower surface of a carriage (not shown) that reciprocates in a main scanning direction perpendicular to the sub-scanning direction. The carriage is guided by a carriage guide shaft (not shown) provided in the main scanning direction, and receives driving force from an endless belt (not shown), provided in a tensioned state similarly in the main scanning direction, so as to reciprocate. Discharging rollers (not shown) comprising a pair of upper and lower discharging rollers, that is, a discharging driven roller and a discharging driving roller, are provided downstream in the sheet transportation direction from the recording position. The sheet P discharged by the discharging rollers is discharged to and stacked upon a placement face of a discharging stacker, which is an example of a liquid ejection medium receiver (not shown).

### Embodiment

Next, the feeding cassette 1 according to the present invention that is mounted to the ink jet printer 100 having such a structure will be described in detail with reference to the drawings.

FIG. 2 is a perspective view of the feeding cassette when the shutter is opened, as seen obliquely from the front side, and FIG. 3 is a perspective view of the feeding cassette when the shutter is closed, as seen obliquely from the front side. FIG. 4 is a side sectional view of the feeding cassette when the hopper is raised, and FIG. 5 is a side sectional view of the feeding cassette when the hopper is lowered. FIG. 6 is a perspective view of the back face side of a cassette body in a feeding cassette for a 4×6 inch size, and FIG. 7 is a perspective showing a state in which a hopper is mounted in FIG. 6. FIG. 8 is a perspective view of the back face side of a cassette body in a feeding cassette for an L-format size, and FIG. 9 is a perspective view showing a state in which a hopper is mounted in FIG. 8. FIG. 10 is a perspective view of a back face side of a cassette body in a feeding cassette for a card size, FIG. 11 is a perspective view showing a state in which a hopper is mounted in FIG. 10, and FIG. 12 is a side sectional view of the feeding cassette to which a shutter is mounted in FIG. 11 when the hopper is raised. FIG. 13 is a perspective view of the back face side of a cassette body in a feeding cassette for a postcard size, and FIG. 14 is a perspective view showing a state in which a hopper is mounted in FIG. 13.

As shown in FIG. 1, the feeding cassette 1 according to the embodiment is used by being mounted to an automatic feeding unit 2. FIG. 1 shows a state in which the feeding cassette 1 is being mounted. The automatic feeding unit 2 is provided in an inner portion at the rear portion side of the printer body 3, and comprises the feeding roller 14 that transports the sheets P by cooperating with (performing a pinch feeding operation with) the hopper 16, a rotatable shaft 18 that rotates together with the feeding roller 14, a motor 31 serving as driving means that transmits rotation to the rotatable shaft 18, a gear train 32 serving as driving transmitting means, and a unit holder 33 that holds these various members and guides the fed sheet P to a sheet transportation path.

The rotation of the rotatable shaft 18 is transmitted to a hopper operating cam 35 and to a rotatable shaft (not shown) of a return lever 7, through the gear train 32, the hopper operating cam 35 being mounted to an end of a hopper operating shaft (not shown). Therefore, the hopper 16 moves vertically at a predetermined timing in response to the rotation of the feeding roller 14, and the return lever 7 operates at a predetermined timing, so that a subsequent, double-fed sheet P is returned towards the feeding cassette 1. In addition, the unit holder 33 is provided with, for example, separating means (not shown) that separates the double-fed sheets P into the topmost sheet P, used for executing recording, and a subsequent sheet P, and a biasing member (such as a helical compression spring) that normally biases the hopper 16 towards the feeding roller 14.

Above the rear portion of the unit holder 33 of the automatic feeding unit 2, a cassette guide 37 whose cross-sectional form is substantially dented is provided in a standing manner obliquely towards the back. The feeding cassette 1 according to the present invention is mounted as a result of being guided by the inner wall surface of the cassette guide 37, and is held with its front side being lower than its back side by the cassette guide 37.

As shown in FIGS. 2 to 7, the feeding cassette 1 according to the embodiment comprises the cassette body 38, an edge guide 15 (FIG. 6), the hopper 16, and a shutter 42. For example, the cassette body 38 can hold approximately 50 sheets P in a stacked state when these sheets P are post cards. The edge guide 15 guides the left and right side edges and the rear end edge of the sheets P held in the cassette body 38. The hopper 16 pushes up the sheets P held in the cassette body 38 towards the feeding roller 14. The shutter 42 closes the opening 41 that opens in a top face 40 at a front end face 39 side of the cassette body 38.

The cassette body 38 is a flat rectangular box-like container. In the embodiment, the top face 40, the front end face 39, a back end face 43, a left side face 44, and a left side face 45 are integrally formed, and a bottom face 46 is open, so that many sheets P can be held. As one distinctive structure of the present invention, three edge guides 15 are provided so as to protrude downward with respect to the inner wall surface of the top face 40 in the cassette body 38. In the description below, when the three edge guides 15 are to be distinguished and described, the edge guide that holds the left side edge of the sheet P is indicated by reference numeral 15A, the edge guide that holds the right side edge of the sheet P is indicated by reference numeral 15B, and the edge guide that holds the rear end edge of the sheet P is indicated by reference numeral 15C. The edge guide 15C need not be provided.

Swing holes 47 and 47 (FIGS. 6 and 7) are provided near corners so as to be provided at locations situated below and towards the back end face 43 in the left and right side faces 44 and 45 of the cassette body 38, and a swing shaft 50, provided at a swing base end portion 49 of the hopper 16, engage these swing holes 47 and 47 (FIGS. 4, 5, and 7). Elastic tongues 52 (FIG. 6) are provided at the locations situated below and towards the front-end-face-39 side in the left and right side faces 44 and 45 of the cassette body 38. Engaging protrusions 54 engaging engagement recesses (not shown), formed in the inner wall surface of the cassette guide 37, are provided at the end portions of the elastic tongues 52.

Engaging pins 56 are provided at the top portions of the respective elastic tongues 52 so as to protrude outward. The engaging pins 56 engage slotted engaging grooves 60 that are bent and formed in left and right side plates 58 and 59 of the shutter 42. Guides 62 (FIG. 6) are provided with the front side being higher than the back side at the inner wall surface sides of the left and right side faces 44 and 45 of the cassette body 38 where the engaging pins 56 are provided. The guides 62 comprise arm-like elastic portions including guide heads 64 provided at ends of the guides 62. The guide heads 64 have circular cylindrical shapes laid horizontally. The guides 62 serve as biasing means that cooperate with elastic operating portions 66 (FIGS. 3 and 5), provided at respective left and right ends of a cover plate 65 of the shutter 42 so as to protrude obliquely downwards, to bias the shutter 42 in a closing direction A.

In addition, guide ribs 69 (FIG. 2) are provided along the longitudinal direction at a height near midpoints of the left and right side faces 44 and 45 of the cassette body 38. The guide ribs 69 slidingly contact the inner side surfaces of the cassette guide 37 of the unit holder 33 to allow smooth mounting and removal of the feeding cassette 1. Rectangular windows 70 (FIG. 2) for confirming the presence and absence of the sheets P and the remaining number of sheets P in the cassette body 38 are provided near the midpoints of and towards the sides of the left and right side faces 44 and 45 in the top face 40 of the cassette body 38.

In the embodiment, the edge guides 15 are integrally formed with the cassette body 38, the protruding ends of all of the edge guides 15A, 15B, and 15C are set so as to be substantially flush with the open bottom face 46 of the cassette body 38. The edge guides 15 are disposed in accordance with the size of the sheets P held in the cassette body 38. More specifically, when the sheets P are 4×6 inch size sheets, as shown in FIG. 6, the inner wall surface, itself, of the left side face 44 of the cassette body 38 corresponds to the edge guide 15A, the inner wall surface, itself, of the right side face 45 of the cassette body 38 corresponds to the edge guide 15B, and the inner wall surface, itself, of the back end face 43 of the cassette body 38 corresponds to the edge guide 15C.

When the sheets P are L-format-size sheets, as shown in FIG. 8, an edge guide 15A is provided slightly inward from a left side face 44 of a cassette body 38, an edge guide 15B is provided slightly inward from a right side face 45 of the cassette body 38, and a edge guide 15C is provided at an inner position situated within ⅕ of the entire length of the cassette body 38 from a back end face 45 of the cassette body 38.

When the sheets P are card-size sheets, as shown in FIG. 10, an edge guide 15A is provided at an inner position situated within ¼ of the width of a cassette body 38 from a left side face 44 of the cassette body 38, an edge guide 15B is provided at an inner position situated within ¼ of the width of the cassette body 38 from a right side face 45 of the cassette body 38, and an edge guide 15C is provided at an inner position situated within ⅖ of the width of the cassette body 38 from a back end face 43 of the cassette body 38.

When the sheets P are postcard-size sheets, as shown in FIG. 13, the inner wall surface, itself, of a left side face 44 of a cassette body 38 corresponds to an edge guide 15A, and the inner wall surface, itself, of a right side face 45 of the cassette body 38 corresponds to an edge guide 15B. An edge guide 15C is provided slightly inward from a back end face 43 of the cassette body 38. Accordingly, in the present invention, since the edge guides 15A, 15B, and 15C are all provided in a fixed state with respect to the cassette body 38, positional adjustments of the edge guides 15, which require precision, are not required, so that, for example, skewing of the sheets P, resulting from positional displacements of the edge guides 15, does not occur.

As shown in FIGS. 5 and 7, the hopper 16 is a flat member that closes the open bottom face 46 of the cassette body 38. As mentioned above, the swing shaft 50 is provided at the swing base end portion 49 of the hopper 16, and can swing between a waiting posture shown in FIG. 5 and a feeding posture shown in FIG. 4, with the swing shaft 50 as a swing fulcrum. Stopper pawls 79 (FIGS. 5 and 7), which are structural members of a stopper structure for preventing movement of the hopper 16 in the opening direction during feeding, are provided between the cassette body 38 and the hopper 16.

A rectangular opening 75 (FIG. 7) is provided in the central portion at a swing-free-end-74 side of the hopper 16. A portion of a push-up operating portion at an end of an operating arm (not shown), mounted to an intermediate portion of a hopper operating shaft (not shown), engages the opening 75, and the other portion of the push-up operating portion is engaged and stopped at the lower surface of a peripheral edge defining the opening 75. Regardless of the raising/lowering position of the hopper 16, as viewed from a side, a placement face of the hopper 16 is always set at a position overlapping the guide surfaces of the edge guides 15 and at a swing angle θ. In addition, the hopper 16 is formed in correspondence with the size of the sheets P held in the cassette body 38 so that it can swing without being interfered by the edge guides 15.

More specifically, when the sheets P are 4×6 inch size sheets, as shown in FIG. 7, a large, rectangular, flat hopper 16 that covers the entire open bottom face 46 of the cassette body 38 is used. When this hopper 16 is to be distinguished from the other hoppers 16 described below, this hopper 16 will be represented as “hopper 16A.” Similarly, a hopper 16 applied to the L-format size cassette body 38 will be represented as “hopper 16B,” a hopper 16 applied to the card-size cassette body 38 will be represented as “hopper 16C,” and a hopper 16 applied to the postcard-size cassette body 38 will be represented as “hopper 16D,” to distinguish the hoppers 16.

As shown in FIG. 9, the hopper 16B used when the sheets P are L-format size sheets has a somewhat narrower width than the hopper 16A used when the sheets P are 4×6 inch size sheets. A slit window 81 that receives the edge guide 15C holding the back end edges of the sheets P is formed at a location towards the swing base end portion 49 of the hopper 16B.

As shown in FIG. 11, the hopper 16C used when the sheets P are card-size sheets is such that its portion situated approximately ⅗ of the entire length of the hopper 16C from the swing free end 74 of the hopper 16 is even narrower in width than the hopper 16B used when the sheets P are L-format size sheets. A window 81 is formed at a location situated approximately ⅖ of the entire length of the hopper 16C from the swing base end portion 49, closer to the swing free end 74 than the location in the hopper 16B.

As shown in FIG. 14, for the hopper 16D used when the sheets P are postcard-size sheets, at the central portion of the swing base end portion 49, a rectangular cutaway portion 82 that receives the edge guide 15C that holds the back end edges of the sheets P, is formed in the hopper 16A used when the sheets P are 4×6 inch size sheets.

As shown in FIGS. 2 to 5, the shutter 42 has a door-shaped cross section formed by the left side plate 58, the right side plate 59, and the cover plate 65. When the shutter 42 receives biasing force generated by contacting the guides 62 of the cassette body 38 and the elastic operating portions 66 of the shutter 42, the shutter 42 is normally positioned at an end portion in a direction A in which the opening 41 of the cassette body 38 is closed as shown in FIGS. 3 and 5. When the feeding cassette 1 is mounted to the inner side surface of the cassette guide 37 in the automatic feeding unit 2 of the recording apparatus, a portion of the shutter 42 is engaged and stopped, and opposes the biasing force, so that the shutter 42 is moved in a direction B in which the opening 41 is opened. That is, guiding the engaging pins 56 by the engaging grooves 60 causes the shutter 42 to move towards an end portion in the opening direction B shown in FIGS. 2 and 4 while being raised somewhat upward.

In the embodiment, a rectangular cutaway portion 78 is provided in the central portion of the front end edge of the cover plate 65. In addition, by causing the feeding roller 14 to enter the cutaway portion 78, the feeding roller 14 can contact the topmost surface of the sheets P whose edges are pushed upward by the hopper 16.

Accordingly, in the embodiment, by providing the edge guides 15 so as to protrude downward from the inner wall surface of the top face 40 of the cassette body 38, the gap existing between the inner wall surface of the top cover and the top end face of the edge guide in the related art does not exist, so that, even if the hopper 16 reaches the raising end, the stability of the orientation of the sheet P is maintained. In addition, due to the disposition of the edge guides 15 in accordance with the size of the sheets P and the form of the hopper 16, it is possible to prevent variations in the positional adjustment of the edge guides 15 performed by a user, so that, for example, skewing of the sheets P during feeding can be prevented.

### Other Embodiments

For example, the feeding cassette 1 and the recording apparatus 100 including the feeding cassette 1 according to the invention of the application have the basic structures described above. Obviously, for example, changes or omissions may be made in part of the structures within the range of the gist of the invention of the application. For example, the length, form, disposition, and number of the edge guides 15 may be changed as appropriate in accordance with differences in the size and form of the recording media P. In addition, it is possible to use various sheet sizes as a result of setting the size of the cassette body 38 to a maximum sheet size, such as a 4×6 inch size, and separately attaching an attachment that is attached to the cassette body 38.

What is claimed is:

1. A feeding cassette comprising:
a cassette body capable of holding many recording media in a stacked state;
an edge guide that guides left and right side edges of the recording media held in the cassette body; and
a hopper that pushes up the recording media held in the cassette body,
wherein the edge guide is provided so as to protrude downward with respect to an inner wall surface of a top face of the cassette body.

2. A feeding cassette comprising:
a cassette body having a top face, a front end face, a back end face, a left side face, and a right side face integrally formed, having an open bottom face, and capable of holding many recording media;
a hopper provided at the cassette body as a structural member forming the bottom face, supporting the recording media held in the cassette body, capable of swinging with a back end as a swing fulcrum, and pushing up the recording media from below by the swinging;
an opening provided in the top face at the front-end-face side of the cassette body; and
an edge guide protruding downward with respect to an inner wall surface of the top face of the cassette body, and guiding left and right side edges of the recording media.

3. The feeding cassette according to claim 2, wherein the edge guide is provided in a fixed state in accordance with a size of the recording media held in the cassette body.

4. The feeding cassette according to claim 3, wherein the hopper is formed with a form corresponding to the size of the recording media held in the cassette body so as not to interfere with the edge guide.

5. The feeding cassette according to claim 3, wherein a placement face of the hopper is formed so as to be positioned in an area interposed between guide surfaces of the edge guide.

6. The feeding cassette according to claim 3, wherein the edge guide is formed integrally with the cassette body, and a protruding end of the edge guide is formed flush with the open bottom face of the cassette body.

7. A recording apparatus to which a feeding cassette is mountable, wherein the feeding cassette comprises a cassette body capable of holding many recording media in a stacked state, an edge guide that guides left and right side edges of the recording media held in the cassette body, and a hopper that pushes up the recording media held in the cassette body towards a feeding roller, and
wherein the feeding cassette is the feeding cassette according to claim 3.

8. A liquid ejecting apparatus to which a feeding cassette is mountable, wherein the feeding cassette comprises a cassette body capable of holding many liquid ejection media in a stacked state, an edge guide that guides left and right side edges of the liquid ejection media held in the cassette body, and a hopper that pushes up the liquid ejection media held in the cassette body towards a feeding roller, and
wherein the edge guide is provided so as to protrude downward with respect to an inner wall surface of a closed top face of the cassette body.
